(19) United States
(12) Patent Application Publication
(10) Pub. No.: US 2011/0033012 A1
(43) Pub. Date: Feb. 10, 2011

(54) CHANNEL ESTIMATOR

(75) Inventors: Hidehiro Matsuoka, Kanagawa (JP); Masami Aizawa, Kanagawa (JP); Tatsuhisa Furukawa, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/834,178

(22) Filed: Jul. 12, 2010

(30) Foreign Application Priority Data
Aug. 4, 2009 (JP) 2009-181821

(51) Int. Cl. H04L 27/06

(52) U.S. Cl. 375/340

(57) ABSTRACT

A channel estimator includes: a delay time estimation section configured to estimate a delay time of a received signal; an FFT parameter determination section configured to determine an FFT window position and an FFT size according to the estimated delay time; a first and a second FFT sections configured to transform the received signal and a known pattern signal, respectively, to the frequency domain based on the FFT window position and the FFT size that are determined; a channel response calculation section configured to perform division processing to divide the output of the first FFT section by the output of the second FFT section; and an IFFT section configured to apply IFFT to the output of the channel response calculation section based on the determined FFT size, and the delay time estimation section estimates a delay time based on the output of the IFFT section.

### CROSS-REFERENCE TO RELATED APPLICATION(S)

This application is based upon and claims the benefit of priority from Japanese Patent Application No. 2009-181821 filed on Aug. 4, 2009, the entire contents of which are incorporated herein by reference.

### BACKGROUND

1. Field

Embodiments described herein relate generally to a channel estimator configured to estimate a channel response in the frequency region, and more particularly to a channel estimator that is used in a receiver in a radio system having a frame configuration in which a specific known pattern signal whose code sequence is cyclically extended is periodically inserted.

2. Description of the Related Art

Generally, in a radio communication/broadcasting system, the waveform of a radio signal transmitted from a transmitting station/broadcasting station may be distorted, because until the radio signal reaches a receiver, the radio signal is reflected, scattered and diffracted by topography, land objects, and the like, so that a plurality of radio waves transmitted through a plurality of paths resulting from the reflection, scattering and diffraction, are synthesized with each other. This phenomenon is generally referred to as multipath.

Thus, in the receiver, processing (equalization processing) is performed, by which the original waveform of the radio signal transmitted from the transmitting station/broadcasting station is extracted from the received signal whose waveform is distorted. In many cases, the equalization processing is performed by digital signal processing. In the processing, it is important to accurately estimate distortion components generated through the multipath channels.

Generally, the distortion components generated through the multipath channels are obtained as a filter response at the time when an impulse is used as an input signal, and hence are expressed by using a channel impulse response (delay profile) which expresses, in the time domain, the propagation delay, the amplitude attenuation, and the phase rotation in each of the paths, and by using a channel frequency response which expresses, in the frequency domain, the frequency characteristics of amplitude and phase in each of the paths. Therefore, the accuracy of the signal distortion equalization processing in the receiver largely depends on the estimation accuracy of these channel responses.

Conventionally, as a channel estimator in a receiver in a radio system, an estimator is known, which is configured to obtain a complex time correlation between a received signal and a reference signal that is a known signal sequence, and which is configured to calculate a delay profile by arranging the complex time correlation in time series (see, for example, “Principles and Applications of CDMA Technology” by Talcum Sato, published by Realize Inc. (see for example, Chapter 1, Section 1.11)).

However, in the conventional channel estimator, there is a problem that since pseudo peaks (referred to as image path) are generated in the delay profile in the case where the received signal has a frame configuration in which a unique word formed by cyclically extending a PN (pseudo random noise) sequence is inserted as the reference signal (known pattern signal), it is not possible to discriminate only actual incoming paths and hence the channel estimation accuracy is significantly deteriorated.

In order to avoid the detection of the image path, instead of the channel estimator configured to obtain correlation in the time domain, a channel estimator configured to estimate the channel response in the frequency domain is proposed (see, for example, Japanese Patent Application Laid-Open Publication No. 2005-51404, Japanese Patent Application Laid-Open Publication No. 2005-223698, J. Wang, etc., “Iteractive padding subtraction of the PN sequence for the TDS-OFDM over broadcast channel,” IEEE Trans. Consumer Electronics, vol. 51, no. 4, pp. 1148-1152, November 2005, and F. Yang etc., “Novel channel estimation method based on PN sequence reconstruction for Chinese DTTB system,” IEEE Trans. Consumer Electronics, vol. 54, no. 4, pp. 1583-1589, November 2008).

Note that Japanese Patent Application Laid-Open Publication No. 2005-51404 discloses a technique that improves the estimation accuracy of the channel characteristics by reducing the adverse influence on the channel estimation values, which influence is caused by that frequency components having a small amount of power are included in the transmission signal.

Japanese Patent Application Laid-Open Publication No. 2005-223698 discloses a technique that improves the accuracy of channel characteristic estimation values obtained by a channel characteristic estimator in a radio communication system using a pilot signal whose frequency characteristics are not flat in the case where the pilot signal is a sequence whose power is fixed in the time domain.

In the above described channel estimator which estimates the channel response in the frequency domain, it is advantageous that the equalization in the frequency domain can be realized without taking into consideration the existence of the image path. However, in the estimator, an FFT window is set so as to include a range from the start of the unique word of the preceding wave to the end of the latest delayed wave. Thus, when the sequence length of the unique word is long, or when the delay time due to the multipath is long, large-size FFT and IFFT need to be performed, which results in a problem that the circuit scale and the processing delay amount are significantly increased. For example, FFT and IFFT of 2048 points are adopted for the unique word of at most 945 symbols in the technique as described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008.

Further, in the case where such large FFT size is used, there is a problem that the estimation accuracy of the channel response is deteriorated because data signals before and after the unique word enter the FFT window to cause interference. To cope with the problem, iterative cancellation processing for generating and subtracting an interference replica is introduced in the technique as described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008. However, this causes the circuit scale to be further increased. Further, in the case where the FFT size is set large beforehand, there is a problem that even when the multipath delay time is actually short, the power consumption of the circuit is too large.

### BRIEF DESCRIPTION OF THE DRAWINGS

FIG. 1 is a diagram explaining, in comparison with a channel response in the time domain, a channel response in the frequency domain, which is used in an embodiment according to the present invention;

FIG. 2 is a diagram showing a channel response in the time domain;

FIG. 3 is a block diagram showing a configuration of a channel estimator according to a first embodiment of the present invention;

FIG. 4 is a diagram explaining a frame format used in the terrestrial digital broadcasting in the People's Republic of China (hereinafter abbreviated as China);

FIG. 5 and FIG. 6 are diagrams which explain, in comparison with a conventional example, an FFT window position and an FFT size in the first embodiment according to the present invention, and FIG. 5 is a diagram explaining a setting method of the FFT window position and the FFT size at the time when (M−N)T of Equation 7, while FIG. 6 is a diagram explaining a setting method of the FFT window position and the FFT size at the time when τ>(M−N)T of Equation 8;

FIG. 7 and FIG. 8 are diagrams which explain, in comparison with a conventional example, another FFT window position setting example based on the FFT window position and the FFT size in the first embodiment according to the present invention, and FIG. 7 is a diagram explaining a setting method of the FFT window position and the FFT size at the time when τ≦(M−N)T of Equation 9, while FIG. 8 is a diagram explaining a setting method of the FFT window position and the FFT size at the time when τ>(M−N)T of Equation 10;

FIG. 9 is a block diagram showing a configuration of a channel estimator according to a second embodiment of the present invention;

FIG. 10 is a diagram showing a preceding wave position and a maximum delay time on a delay profile;

FIG. 11A and FIG. 11B are diagrams which show, on a delay profile, relationships between a preceding wave and a main wave, and FIG. 11A is a diagram showing a case where the preceding wave is different from the main wave, while FIG. 11B is a diagram showing a case where the preceding wave coincides with the main wave;

FIG. 12 is a block diagram explaining a configuration of a conventional channel estimator;

FIG. 13 is a block diagram explaining a configuration of a correlator of the conventional channel estimator; and

FIG. 14 is a diagram schematically explaining a configuration of a frame having a cyclically extended unique word.

### DETAILED DESCRIPTION

In the following, embodiments according to the present invention will be described with reference to the accompanying drawings.

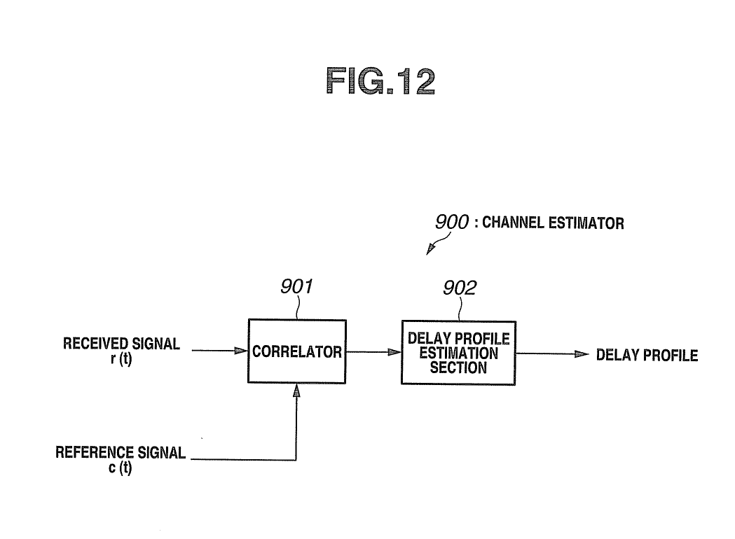

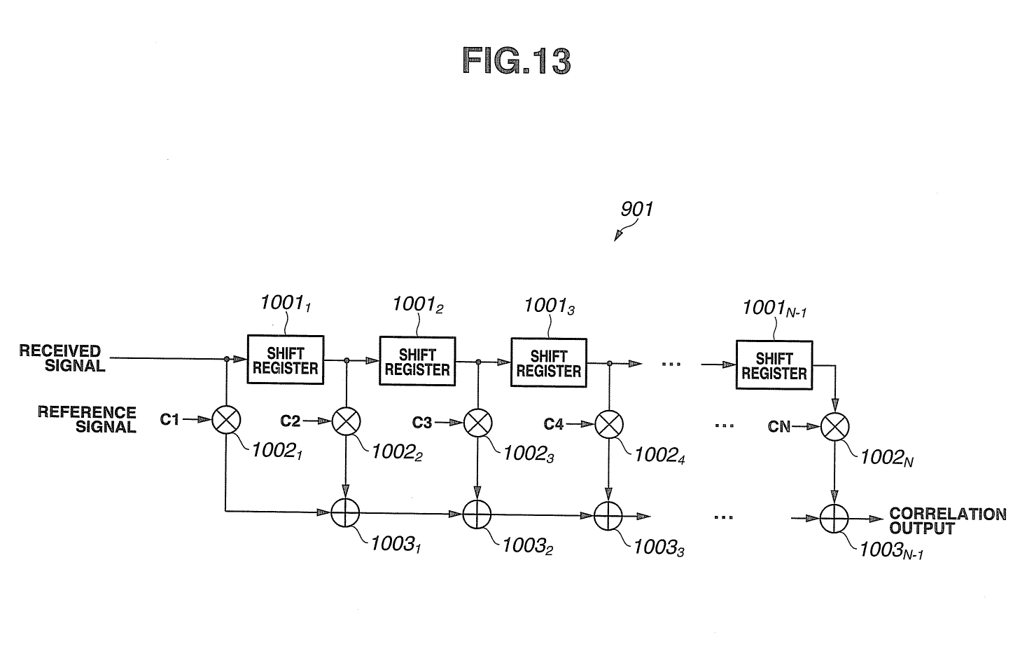

FIG. 12 is a block diagram showing a channel estimator of a conventional example, and showing a channel estimator in the time domain. FIG. 13 shows a correlator in FIG. 12.

In FIG. 12, a channel estimator 900 includes a correlator 901 configured to detect correlation between a received signal and a known reference signal, and a delay profile estimator 902 configured to estimate a delay profile on the basis of the output of the correlator 901.

When the received signal is set as r(t) and the reference signal is set as c(t), and when a delay time is set as τ, the conventional channel estimator as described in “Principles and Applications of CDMA Technology” by Takuro Sato, published by Realize Inc. (see, for example, Chapter 1, Section 1.11), accumulates the results of Equation (1) described below in a memory and arranges the results in time series so as to output the arranged results as a delay profile.

$${\int }_{0}^{Ts} r ( t + τ ) c ( τ ) d τ \qquad ( 1 )$$

Note that in Equation (1), Ts designates the sequence length of the reference signal c(t). In the discrete-time digital signal domain, the integration of Equation (1) can be transformed into Equation (2) described below.

$${\sum }_{K = 1}^{N} r ( n - k \cdot Δ t ) {c}_{k} \qquad ( 2 )$$

Note that in Equation (2), Δt designates a sampling interval. Therefore, Equation (2) can be realized by hardware of a transversal filter with N taps as shown in FIG. 13.

In the correlator 901 shown in FIG. 13, the received signal is inputted into shift registers 1001₁ to 1001_{(N-1)}, and complex multiplication of each of the tap outputs with each component of a reference signal sequence {C1, C2, C3, . . . , CN} is performed by each of multipliers 1002₁ to 1002_{N}. Thereafter, the multiplication results are added together by adders 1003₁ to 1003_{(N-1)}.

Generally, in the CDMA (Code Division Multiple Access) system and a radio system including a specific known pattern, Equation (2) is realized by hardware using a sliding correlator or a matched filter.

On the other hand, depending on a radio system, there is a case where a specific known pattern is periodically inserted, which is formed in such a manner that a cyclic prefix and a cyclic postfix, each of which is formed by cyclically extending a specific code sequence (such as, for example, PN sequence), are respectively inserted before and after the specific code sequence (hereinafter, such known pattern or known pattern signal is expressed as unique word). Here, in the unique word, the same code sequence is included in the cyclic prefix and the end region of the PN sequence, while the same code sequence is included in the cyclic postfix and the starting region of the PN sequence.

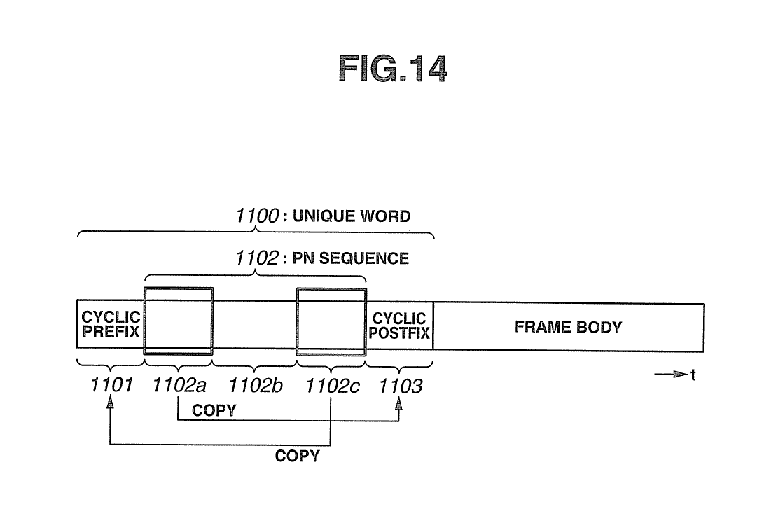

FIG. 14 is a schematic diagram explaining a configuration of a frame having a cyclically extended unique word.

As shown in FIG. 14, a unique word 1100 is configured by a cyclic prefix 1101 (for example 82 symbols), a PN sequence 1102 (for example 255 symbols) as a specific code sequence, and a cyclic postfix 1103 (for example 83 symbols). The length of the unique word can be expressed as the sum of the lengths of these codes, and hence the length of the unique word is obtained, for example, as 82+255 +83=420 symbols. Here, the PN sequence 1102 is configured by a starting region 1102a, a center region 1102b, and an end region 1102c. The cyclic prefix 1101 is formed by the same code sequence as that of the end region 1102c (for example, 82 symbols) of the PN sequence, while the cyclic postfix 1103 is formed by the same code sequence as that of the starting region 1102a (for example, 83 symbols) of the PN sequence.

Here, it is assumed that a signal frame (hereinafter simply referred to as frame) is configured by the unique word as a frame header, and a frame body as a data section, and that the frames having the same configuration are continuously or intermittently arranged in series. When a delay profile is calculated by obtaining correlation between a received signal and a reference signal (unique word) by using a conventional channel estimator as described in “Principles and Applications of CDMA Technology” by Takuro Sato, published by Realize Inc. (see, for example, Chapter 1, Section 1.11) as shown in FIG. 12, several pseudo peaks (image paths) are generated by a partial correlation between these signals at a time other than when a true delay path exists. That is, at the time when the cyclic prefix 1101 overlaps with the end region 1102c of the PN sequence, and when the cyclic postfix 1103 overlaps with the starting region 1102a of the PN sequence, a partial correlation between the received signal and the reference signal is caused in the multiplication processing performed by the multiplier in the correlator shown in FIG. 13, so that image paths are generated.

In this way, the conventional channel estimator has a problem that in the case where the received signal has the frame configuration in which the unique word is inserted, since an image path is generated in the delay profile on the basis of the results of calculation performed by the correlator in the channel estimator, it is not possible to discriminate only actual incoming paths and thereby the channel estimation accuracy is significantly deteriorated.

In order to avoid that the image path is detected, a channel estimator is proposed which, instead of obtaining the correlation in the time domain, estimates the channel response in the frequency domain.

A received signal is obtained by convolution of a unique word with a channel impulse response. Thus, in the channel estimator configured to estimate a channel response in the frequency domain, the channel impulse response h in the time domain can be obtained in such a manner that the received signal transformed to the frequency domain is divided by the known unique word transformed to the frequency domain, and that the division result is again transformed to the time domain (see Equation (3) described below).

$$h = IFFT [ \frac{FFT ( r ( t ) )}{FFT ( c ( T ) )} ] \qquad ( 3 )$$

In the channel estimator configured to estimate the channel response in the frequency domain described above, the equalization in the frequency domain can be realized without taking into consideration the existence of the image path. However, in the case where the sequence length of the unique word is long, and where the delay time due to the multipath is long, since the FFT window is set so as to include the period from the start of the unique word of the preceding wave to the end of the unique word of the latest delayed wave, FFT and IFFT with a large FFT size are required, which results in a problem that the circuit scale and the processing delay amount are significantly increased. For example, as described above, FFT and IFFT of 2048 points are adopted for a unique word of at most 945 symbols in the technique described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008.

Further, there is a problem that in the case of such large FFT size, the channel estimation accuracy is deteriorated because the data signals before and after the unique word is included in the FFT window so as to interfere with the unique word. To cope with this problem, the iterative cancellation processing for generating and subtracting an interference replica is introduced in the technique described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008. However, this results in a further increase in the circuit scale.

Further, since the FFT size is set large beforehand, there is a problem that even when the multipath delay time is actually short, the FFT processing load is heavy and hence the circuit power consumption is too large.

Thus, embodiments according to the present invention are configured such that when a signal has a frame configuration in which a specific known pattern formed by cyclically extending a code sequence is periodically inserted, and when the delay time of the signal is short, the FFT size can be reduced to reduce the circuit power consumption, and also extra interference symbols can be reduced to prevent the deterioration of the channel estimation accuracy.

### First Embodiment

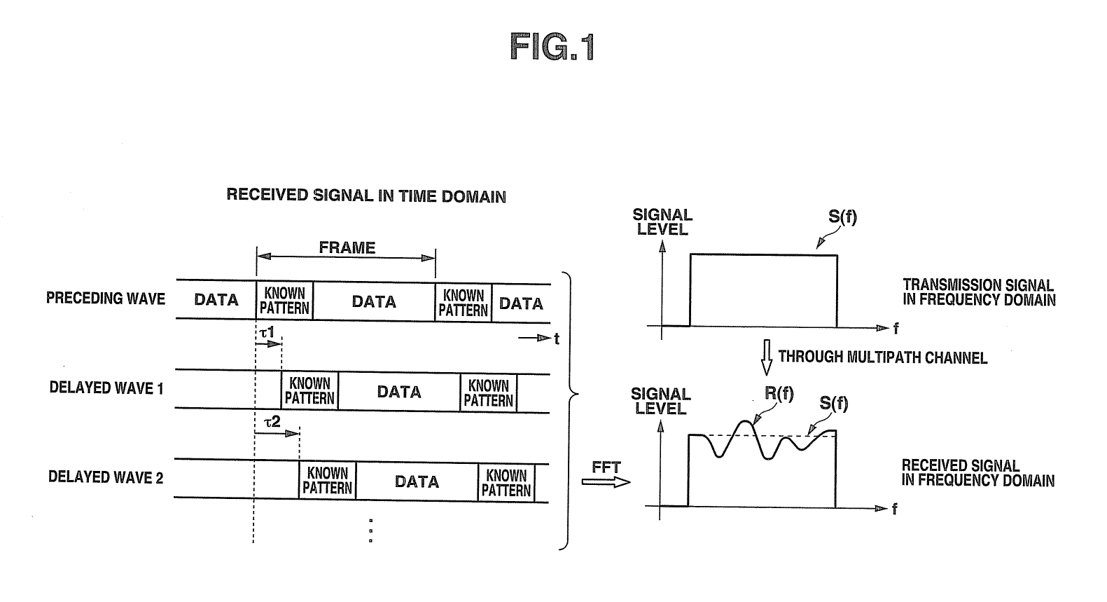

In the following, a configuration of a channel estimator according to a first embodiment of the present invention will be described with reference to FIG. 1 to FIG. 8.

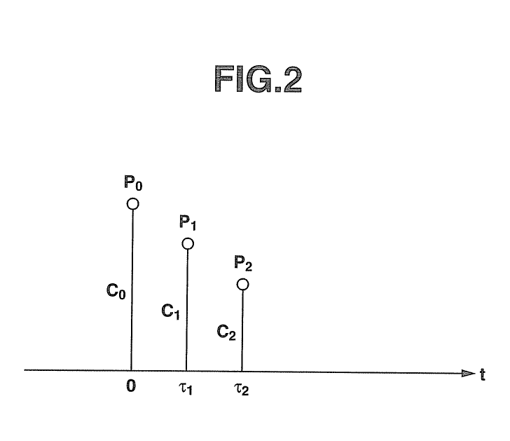

First, the channel response in the frequency domain, which is used in the embodiment according to the present invention, will be described with reference to FIG. 1 and FIG. 2. Here, the channel response in the frequency domain is described in comparison with the channel response in the time domain.

FIG. 1 is a diagram for explaining a received signal in the time domain (time axis t), a received signal in the frequency domain (frequency axis f), and a relationship between the signals in the time and frequency domains, in a radio system where the transmitted signal consists of continuous frames having a configuration in which a known pattern signal formed by cyclically extending a PN sequence as a specific code sequence is periodically inserted as the frame header.

Received signals transmitted from a transmitting station/broadcasting station and received by the receiver through radio channels include a main wave which directly reaches the receiver and has a high signal power and plural delayed waves, each of which is received with a time delay after being reflected by a building, a mountain, and the like. Two delayed waves are assumed in FIG. 1. One frame of the received signal is configured by a known pattern and data subsequent to the known pattern. In the receiver, such frames are received continuously or intermittently.

In the case where the channel response is estimated in the time domain, when a correlation (similarity) between the multipath synthesized wave as the received signal and the known pattern is detected per frame by moving (sweeping) the known pattern on the time axis with respect to the multipath synthesized wave, one peak P0 is detected, as shown in FIG. 2, at the time when the known pattern coincides with a signal pattern in the multipath synthesized wave (the delay time at this time is set to 0). After “0” indicating no coincidence between the patterns continues for a while, one peak P1 is detected at the time when the known pattern again coincides with a signal pattern in the multipath synthesized wave (the delay time at this time is set to τ1). Further, after “0” continues for a while, one peak P2 is detected at the time when the known pattern again coincides with a signal pattern in the multipath synthesized wave (the delay time at this time is set to τ2). In this way, the peaks P0, P1, P2, . . . are successively detected as the delay waves of the multipath synthesized wave. Therefore, the correlation between the multipath synthesized wave and the known pattern is represented as the state where peaks P0, P1, P2, . . . are arranged along the time axis t.

In FIG. 2, when channel coefficients of the peaks P0, P1, P2, . . . are respectively set as C0, C1, C2, . . . , and when the signals of the main wave and the delayed waves are respectively set as S(t), S(t−τ1), S(t−τ2), . . . , the received signal R(t) in the time domain is expressed in a convolution form as shown by Equation (4).

$$R ( t ) = {\sum }_{i = 0}^{N} C i \cdot S ( t - τ i ) \qquad ( 4 )$$

Here, Ci designates a channel coefficient, and S(t−τi) (i=0 to N) designates the signal of the main wave and each of the signals of the delayed waves. Reference character τ0 means the delay time 0.

In Equation (4), the value of the channel coefficient Ci is changed according to where the radio signal is reflected or absorbed. The respective (convolution operation) terms in Equation (4) are added together in such a manner that the direct wave directly coming to the receiver and the delayed waves delayed from the direct wave are not added coherently in the same phase.

When the received signal R(t) in the time domain expressed by Equation (4) is subjected to fast Fourier transform (FFT) by the FFT section, so as to be transformed to a signal in the frequency domain, the received signal R(f) in the frequency domain is expressed by Equation (5).

$$\begin{matrix}R ( f ) = C ( f ) \times S ( f ) \\ = ( {\sum }_{i = 0}^{N} C i ( f ) ) \times S ( f )\end{matrix} \qquad ( 5 )$$

Here, C(f) designates a spectrum of the channel coefficient in the frequency domain, and S(f) designates a spectrum of the known signal in the frequency domain.

A transmission signal, which has frequency spectrum S(f) as shown in FIG. 1 before being transmitted through the channels, is changed by the superposition of a plurality of delayed waves while being transmitted through the channels. As a result, the frequency spectrum of the received signal are changed to have wavy characteristics like the received signal R(f) shown in FIG. 1.

Meanwhile, as shown by Equation (5), the received signal R(f) in the frequency domain is expressed as received signal R(f)=[channel coefficient C(f) in the frequency domain]×[known signal S(f) in the frequency domain]. Thus, when the known signal S(f) in the frequency domain is known, [channel coefficient C(f) in the frequency domain] as the channel response can be obtained by calculating [received signal R(f) in the frequency domain]/[known signal S(f) in the frequency domain].

When the channel coefficient C(f) in the frequency domain is subjected to inverse fast Fourier transform (IFFT), a channel impulse response, that is, a delay profile can be obtained. Therefore, the maximum delay time τ can be estimated from the obtained delay profile. The estimation is performed according to the change of the received signal R(f) in the frequency domain. Thus, in the case where the FFT size and the FFT window position are determined according to the estimated maximum delay time τ, and where the FFT section and the IFFT section in the channel estimator are operated in the frequency domain on the basis of the determined FFT size, when the maximum delay time τ is short, the FFT and IFFT processing can be performed by reducing the FFT size. Thereby the operation amount of FFT and IFFT processing and the circuit scale can be reduced, so that wasteful power consumption in the circuit can be suppressed.

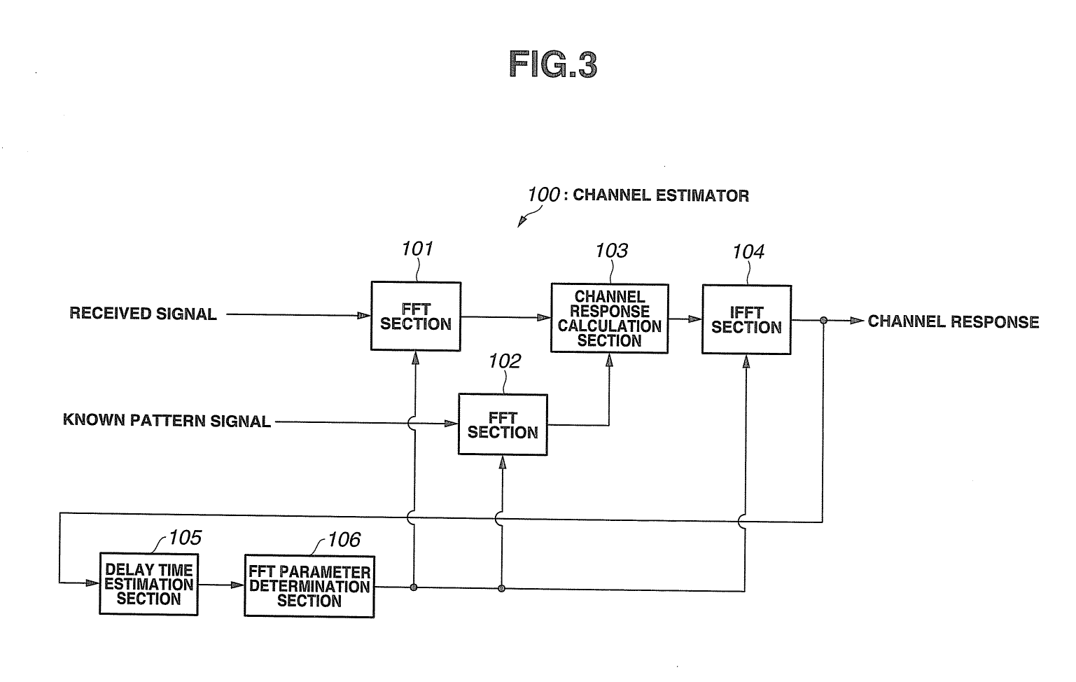

FIG. 3 is a block diagram showing a configuration of a channel estimator according to the first embodiment of the present invention. Note that frame synchronization needs to be completed beforehand in order to perform the channel estimation which is an object of the first embodiment of the present invention. Thus, a case where the preceding wave position P is separately made known by a frame synchronization detection circuit, and the like, is described in the present embodiment.

As shown in FIG. 3, a channel estimator 100 according to the first embodiment of the present invention includes: a first FFT section 101 configured to transform a received signal to the frequency domain; a second FFT section 102 configured to transform a known pattern signal or a subsequence of the unique word to the frequency domain; a channel response calculation section 103 configured to calculate a channel response by using the output of first FFT section 101 and the output of the second FFT section 102; an IFFT section 104 configured to transform the output signal of the channel response calculation section 103 to the time domain; a delay time estimation section 105 configured to estimate a delay time (for example, maximum delay time c) from the output of the IFFT section 104; and an FFT parameter determination section 106 configured to determine an FFT window position and an FFT size according to the delay time estimated by the delay time estimation section 105. The processing of the first and second FFT sections 101 and 102, and the processing of the IFFT section 104 are performed on the basis of the FFT window position and the FFT size which are determined by the FFT parameter determination section 106. Note that the FFT parameter determination section 106 may be configured to switch between a predetermined FFT size (initial setting size) and an FFT size smaller than the predetermined FFT size according to, for example, the delay time estimated by the delay time estimation section 105.

The first FFT section 101 transforms the received signal to the frequency domain on the basis of the FFT window position and the FFT size which are determined by the FFT parameter determination section 106. The second FFT section 102 transforms the known pattern signal to the frequency domain on the basis of the FFT size determined by the FFT parameter determination section 106. The channel response calculation section 103 calculates a channel response by performing processing to divide the FFT output of the first FFT section 101 by the FFT output of the second FFT section 102. The IFFT section 104 applies IFFT to the output of the channel response calculation section 103 on the basis of the FFT size determined by the FFT parameter determination section 106.

The channel response calculation section 103 divides the FFT output of the received signal by the FFT output of the known pattern signal, as shown by Equation (3). This is an estimation method based on the zero forcing (ZF) algorithm. However, in the ZF algorithm, in the case where the amplitude of a specific subcarrier (frequency component) is too small among the FFT outputs of the known pattern signal, when the denominator of the division at the frequency component becomes close to 0, the calculation accuracy becomes insufficient, and thereby the division result becomes a very large value. This results in a problem that the noise component included in the received signal is extremely emphasized so that the result of equalization based on the channel response becomes incorrect. This problem is caused in the case where the amplitude change of the frequency response of the known pattern signal is small, and where the amplitude of a specific subcarrier of the received signal is made extremely small due to the multipath. The above described problem of noise emphasis can be solved in such a manner that the channel response is estimated by using the Minimum Mean Square Error (MMSE) algorithm as shown by Equation (6). Here, h designates a channel impulse response in the time domain, R designates a frequency response of a received signal, C designates a frequency response of a known pattern signal, and σ² designates noise power. The symbol * designates a complex conjugate.

$$h = IFFT [ \frac{R \cdot {C}^{*}}{{\vert C \vert}^{2} + {σ}^{2}} ] \\ R = FFT [ r ( t ) ] \\ C = FFT [ c ( t ) ] \qquad ( 6 )$$

The noise power is estimated by using a value of squared Euclidean distance between the reference signal and the demodulation signal which is subjected to the signal determination after the equalization. Alternatively, as the noise power estimation value, a value may be set, which is obtained by integrating electric power of a time waveform (delay profile) of a channel response only during a period in which it is possible to express, by the delay profile, the power of the waveform at the time when the path electric power is not more than a predetermined threshold value.

In the delay time estimation section 105, the delay time τ of each delayed wave is obtained from the time domain channel response (delay profile) obtained as the output of the IFFT section 104. For example, a path having a maximum power is searched in the delay profile. Then, a path, which has a power larger than a predetermined attenuation level relative to the maximum power level of the searched path, is recognized as a delayed wave, so that the delay time of the recognized paths is measured. Note that it is assumed that one or more delayed waves are recognized.

In the FFT parameter determination section 106, the FFT window position and the FFT size corresponding to the delay time (for example, maximum delay time) estimated by the delay time estimation section 105 are determined. This processing is essential for the method of estimating the channel response in the frequency domain, similarly to the conventional example as described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system, “IEEE Trans. Consumer Electronics, vol. 54, no. 4, pp. 1583-1589, November 2008.

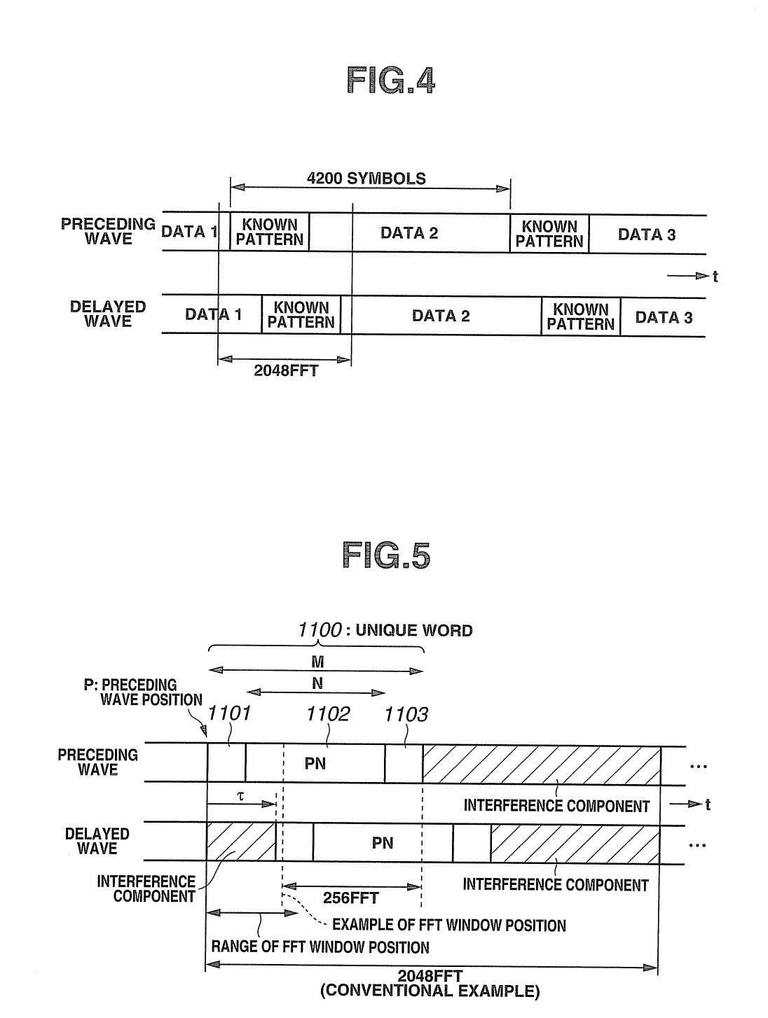

FIG. 4 is a diagram explaining a frame format used in terrestrial digital broadcasting in China and the relationship between each path delay of the multipath and the FFT size used in the conventional method. One frame of the system shown in FIG. 4 is configured by a known pattern and data. The known pattern is configured by including a cyclic prefix, a PN sequence, and a cyclic postfix, similarly to the unique word shown in FIG. 14 and in FIG. 5 as will be described below. In the terrestrial digital broadcasting in China, three kinds of the number of symbols per frame are prepared, and FIG. 4 shows, for example, the case where one frame length is set to 4200 symbols.

In the conventional channel estimation in the frequency domain, a fixed large FFT size (for example, 2048 points) is used so as to include the maximum delay time of the known pattern or the unique word.

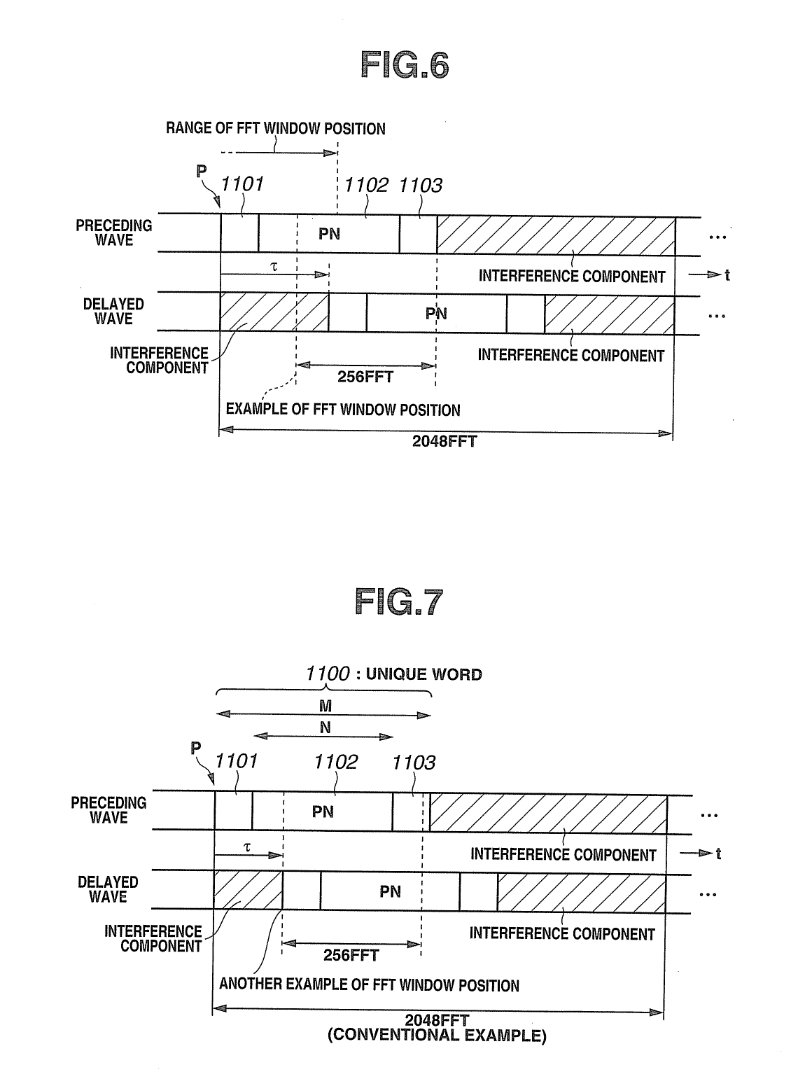

FIG. 5 and FIG. 6 show differences in the FFT window position and the FFT size between the first embodiment according to the present invention and the conventional example as described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008. FIG. 5 is a diagram explaining a setting method of the FFT window position and the FFT size in the case where the maximum delay time τ expressed by Equation (7) as will be described below is not more than a predetermined value. FIG. 6 is a diagram explaining a setting method of the FFT window position and the FFT size in the case where the maximum delay time τ expressed by Equation (8) as will be described below is more than the predetermined value. Note that the preceding wave shown in FIG. 5 and FIG. 6 is usually equivalent to the main wave having the maximum signal power. However, when the channel is non-line of sight (NLOS) from the broadcasting station antenna to the receiver, a reflected incoming delayed wave may have the maximum signal power to become a main wave. In any one of the cases, the delayed wave shown in FIG. 5 and FIG. 6 means the delayed wave having the maximum delay time among a plurality of delayed waves that can be recognized as delayed waves generated from the preceding wave.

As shown in FIG. 5 and FIG. 6, in the conventional example, a comparatively large FFT size is set so that the FFT window starts from the starting position of the unique word as the known pattern of the preceding wave and includes the end of the unique word of the delayed wave. For example, in the case where the length of PN sequence 1102 included in the unique word 1100 is set as N, and where the length of the unique word (that is, the known pattern signal length) including the PN sequence 1102 and cyclically extended portions 1101 and 1103 is set as M, even when N=255 symbols and M=420 symbols are used as one set of parameters in the terrestrial broadcasting in China, 2048 points (hereinafter abbreviated as 2048 FFT) are used as the FFT size. In the case of this FFT size, there is a problem that the estimation error of the channel response is increased because, other than PN sequence 1102 and cyclically extended portions 1101 and 1103, which are necessary to actually estimate the channel response and which are included in the preceding wave and the delayed waves, many data symbols before and after the necessary sequence and portions are included as interference signals (hatched portions in the figure) in the FFT. To cope with this problem, an interference canceller is introduced to reduce the estimation error so as to improve the performance in the conventional example as described in J. Wang, etc., “Iterative padding subtraction of the PN sequence for the TDS-OFDM over broadcast channel,” IEEE Trans. Consumer Electronics, vol. 51, no. 4, pp. 1148-1152, November 2005, and described in F. Yang, etc., “Novel channel estimation method based on PN sequence reconstruction for Chinese DTTB system,” IEEE Trans. Consumer Electronics, vol. 54, no. 4, pp. 1583-1589, November 2008. However, in this measure, the circuit scale is increased in exchange for the performance improvement.

On the other hand, in the embodiment according to the present invention, it is possible to adaptively change the FFT size and the FFT window position according to a delay time (for example, maximum delay time). Each of the first and second FFT sections 101 and 102, and of the IFFT section 104 is configured by a plurality of stages of butterfly operation circuits having a radix of two or more, and hence has flexibility in the FFT size in correspondence with the number of combinations of the circuits.

When the maximum delay time ti is not more than the time ((M−N)T) corresponding to the cyclically extended portions 1101 and 1103, the FFT size is adaptively selected so as to include a part of the PN sequence or cyclically extended portions, of the preceding wave and of all the delayed waves. That is, the FFT size is not less than the N points of the PN sequence and not more than the M points of the unique word length.

Alternatively, when the maximum delay time ti is more than the time ((M−N)T) corresponding to the cyclically extended portions 1101 and 1103, the FFT size is adaptively selected so as to have more points than the length corresponding to the cyclically extended portions 1101 and 1103. That is, the FFT size is larger than the cyclically extended portions 1101 and 1103.

In summary, when it is set that t is the maximum delay time, T is the symbol time, P is the preceding wave position, and K is the FFT size, the FFT sizes to be selected are expressed as follows.

When τ≦(M−N)T,

FFT size K=any arbitrary value from N to M

FFT window position=P+M−K (7)

When τ>(M−N)T,

FFT size K=any arbitrary value satisfying τ<KT

FFT window position=P+M−K (8)

Here, the term (M−N) is equivalent to the length of the cyclically extended portions (=cyclic prefix+cyclic postfix). Further, the meaning of (P+M−K) of the FFT window position is as follows. That is, the term (P+M) means the addition of the unique word length M to the preceding wave position P, and expresses the position of the end of the unique word. Therefore, the term (P+M−K) expresses the position returned from the end of the unique word by the FFT size K, and the position is set as the FFT window position.

As shown in FIG. 5, in the case where τ≦(M−N)T, for example, in the case where, when M=420 and N=255, the maximum delay time T is not longer than the time corresponding to (M−N=) 165 symbols, it is sufficient to set the FFT size to about 256 points (abbreviated as 256FFT). In the case where the maximum delay time τ of the latest delayed wave among the plurality of recognized delay waves satisfies the condition of Equation (7), the FFT size is set to about 256 points. In the case, the FFT window position can be set so as to include a part of the PN sequence and the cyclically extended portion and almost no interference component is included in the range of the FFT size. Note that according to Equation (7), the FFT size is precisely in the range from 255 to 420 (inclusive). However, when the FFT size exceeds 256 points, the FFT window position may be set to a position in the interference region (hatched region in the figure) of the delayed wave, and hence interference components may be included in the FFT size, so as to deteriorate the channel response.

Further, in the case where of τ>(M−N)T as shown in FIG. 6, that is, in the case where the maximum delay time τ is longer than the time corresponding to 165 symbols, the FFT size K is set to the number of points (the number of symbols) corresponding to the time longer than the maximum delay time T. In the case where the maximum delay time τ of the latest delayed wave among the plurality of recognized delayed waves satisfies the conditions of Equation (8), the FFT size may be set to 167 points or more. However, when the FFT size is set to 167 points or more, the FFT window position may be set to a position in the interference region (hatched region in the figure) of the delayed wave, and hence interference components may be included in the FFT size, so as to deteriorate the channel response. Therefore, in the FFT size slightly larger than 167 points (that is, the maximum delay time τ slightly longer than the time corresponding to 165 points), because the FFT size is smaller than the PN sequence length (255 points), sufficient frequency information becomes difficult to be obtained, whereas the FFT processing is performed in the effective region of the preceding wave and of the delayed waves so as to lower the possibility that the interference components of the preceding wave and of the delayed waves are included. On the other hands, when the maximum delay time τ is further longer than the time corresponding to, 165 points, particularly exceeding 255 points, the FFT processing may be performed in the effective region of only the preceding wave, but the region of the interference components of the delayed wave is increased.

FIG. 6 shows the case where the FFT size is set to 256 points, similarly to the case shown in FIG. 5. In the case where the maximum delay time τ is short as in the case shown in FIG. 5, when the FFT size is set to 256 points, the channel estimation is hardly affected by the interference components. However, in the case where the maximum delay time t is long as in the case shown in FIG. 6, when the FFT size is set to 256 points, the interference components (hatched region) of the delayed wave are included in the FFT size, so as to deteriorate the channel response.

However, in the initial state, a delay profile is not obtained and the maximum delay time τ is not known. Thus, as the first step, the size of FFT and IFFT is first fixed to the maximum size (for example, 2048 points) that can be assumed as the multipath delay time, and the FFT processing and the IFFT processing are performed on the basis of the FFT size. From the obtained channel response, the maximum delay time τ is obtained by the delay time estimation section 105. In the second step, an accurate channel response is estimated in such a manner that, on the basis of Equation (7) expressing the relationship between the maximum delay time τ, the PN sequence length N, and the unique word length M, the respective FFT size of the first and second FFT sections 101 and 102, and of the IFFT section 104 is made variable in the FFT parameter determination section 106 according to the maximum delay time t. Note that the above described operation flow can be performed on the basis of the control of the control section (not shown).

Thereby, when the maximum delay time τ obtained by the delay time estimation section 105 is short, it is possible to obtain the effect that the power consumption of the circuit can be reduced by reducing the FFT size, and also the effect that extra interference symbols can be reduced as much as possible thereby preventing deterioration of the channel estimation accuracy.

Note that the other criterion regarding the FFT window position as expressed by Equation (7) and Equation (8), is the delay time of the latest delayed wave having power not less than a predetermined threshold value may also be used as the FFT window position setting reference. A fixed value set beforehand or a value attenuated by a predetermined level relative to the maximum power value of the delayed waves may be used as the predetermined threshold value used for recognizing the latest delayed wave.

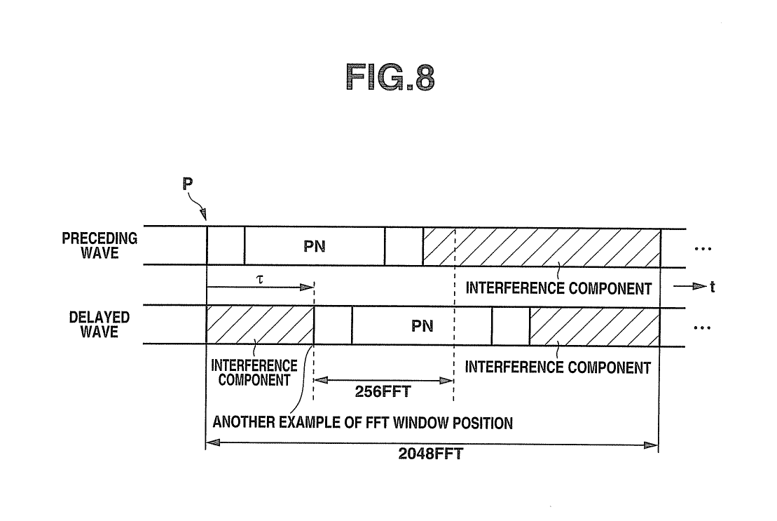

FIG. 7 and FIG. 8 are diagrams which explain, in comparison with the conventional example, another FFT window position setting example based on the FFT window position and the FFT size in the first embodiment according to the present invention, and FIG. 7 is a diagram explaining, as expressed in Equation (9), a setting method of the FFT window position and the FFT size when τ≦(M−N)T, while FIG. 8 is a diagram explaining, as expressed in Equation (10), a setting method of the FFT window position and the FFT size when τ>(M−N)T. In FIG. 7 and FIG. 8, only the FFT window position setting method is different from the method expressed by Equation (7) and Equation (8), and the FFT size setting method is the same as the method expressed by Equation (7) and Equation (8).

When τ≦(M−N)T,

FFT size K=any arbitrary value from N to M

FFT window position=delay time of the latest delayed wave (9)

When τ>(M−N)T,

FFT size K=any arbitrary value satisfying τ<KT

FFT window position=delay time of the latest delayed wave (10)

According to the first embodiment, in the first step, the size of FFT and IFFT are fixed to the size that can include the maximum delay time (for example, 2048 points), to obtain a channel response, and then the maximum delay time τ is obtained from the obtained channel response. In the next step, on the basis of Equations (7) and (8) or Equations (9) and (10), which express the relationship between the maximum delay time τ, the PN sequence length N, and the unique word length M, an accurate channel response is estimated by making the size of FFT and IFFT variable according to the maximum delay time τ. As a result, when the maximum delay time τ obtained by the delay time estimation section 105 is short, the circuit power consumption can be reduced by reducing the FFT size, and the deterioration of channel estimation accuracy can be prevented by reducing extra interference symbols.

### Second Embodiment

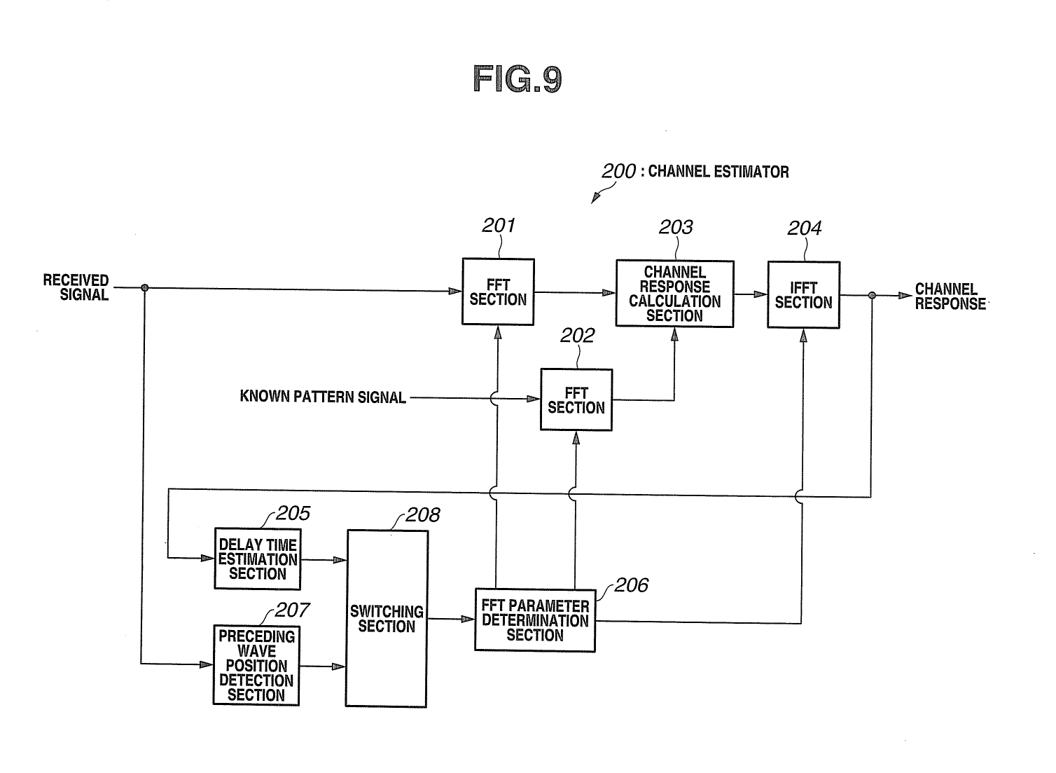

FIG. 9 is a block diagram showing a configuration of a channel estimator according to a second embodiment of the present invention.

In the second embodiment, the case where the preceding wave position is not known is assumed. In this case, it is necessary to know the delay time (for example, the maximum delay time τ) of the delayed wave and the preceding wave position P in order to set the FFT size and the FFT window position in the FFT parameter determination section 206.

A channel estimator 200 shown in FIG. 9 includes: a first FFT section 201 configured to transform a received signal to the frequency domain; a second FFT section 202 configured to transform a known pattern signal or a subsequence, such as a unique word, to the frequency domain; a channel response calculation section 203 configured to calculate a channel response by using the output of the first FFT section 201 and the output of the second FFT section 202; an IFFT section 204 configured to transform the output signal of the channel response calculation section 203 to the time domain; a delay time estimation section 205 configured to estimate a delay time (for example, the maximum delay time τ) from the output of the IFFT section 204; a preceding wave position detection section 207 configured to receive the received signal and to detect a preceding wave position P; a switching section 208 configured to receive the output of the delay time estimation section 205 and the output of the preceding wave position detection section 207 to output any one of the outputs of the sections by switching between the outputs of the sections; and an FFT parameter determination section 206 configured to determine the FFT window position and the respective FFT size of the first and second FFT sections 201 and 202, and of the IFFT section 204 according to the maximum delay time τ estimated by the delay time estimation section 205 or according to the preceding wave position P detected by the preceding wave position detection section 207. Each of the sections designated by reference numerals 201 to 206 corresponds to each of the sections designated by reference numerals 101 to 106 shown in FIG. 3, and has the same function as that of each of the sections shown in FIG. 3.

The first FFT section 201 transforms the received signal to the frequency domain on the basis of the FFT window position and the FFT size which are determined by the FFT parameter determination section 206. The second FFT section 202 transforms the known pattern signal to the frequency domain on the basis of the FFT size determined by the FFT parameter determination section 206. The channel response calculation section 203 calculates the channel response by dividing the FFT output of the first FFT section 201 by the FFT output of the second FFT section 202. The IFFT section 204 applies IFFT to the output of the channel response calculation section 203 on the basis of the FFT size determined by the FFT parameter determination section 206.

The major difference between the configuration of the second embodiment according to the present invention and the configuration of the first embodiment shown in FIG. 3 is that the preceding wave position detection section 207 configured to detect the preceding wave position, and the switching section 208 configured to switch the input to the FFT parameter determination section 206 are added.

The preceding wave position detection section 207 is realized by performing the preceding wave position detection processing described below. In an example of the preceding wave position detection method performed in the preceding wave position detection section, complex correlation processing between a known signal, such as the unique word, and a received signal continues to be performed in the time domain to obtain a correlation result, and then a position, at which a peak of the correlation value representing the correlation result is detected, is set as the preceding wave position P. Further, when the position P is varied for each frame, the correlation results between the known signal and the plurality of frames may be averaged, or a predetermined condition may also be set to perform synchronization protection to provide synchronization of the peak detection position P between the frames. Alternatively, the correlation of a pair of the cyclically extended portions (the pair of the portions designated by reference numerals 1101 and 1102c or by reference numerals 1103 and 1102a in FIG. 14) between the known signal and the received signal may continue to be taken, so as to set, as the position P, the position at which the correlation value becomes a maximum. In any case, it is only necessary that the delay time between the preceding wave position P and each of the delayed waves can be temporarily determined by performing correlation processing between the known signal and the received signal. Thus, the accuracy of the absolute value of the peak value does not need to be high, and only a degree of the estimation accuracy which enables the peak to be discriminated is needed.

The preceding wave position detection section 207 also obtains correlation between the received signal and the unique word as the known pattern signal having at least the sequence length N of the PN sequence, and performs threshold determination on the power value of the correlation value representing the obtained correlation result. The preceding wave position detection section 207 does not regard, as the preceding wave, the received signal corresponding to the power value less than the threshold value. The synchronization is taken by the preceding wave position detection processing performed in this way.

The maximum delay time τ is not known at first. Thus, as the first step, the sizes of FFT and IFFT are fixed to the size that can include the maximum delay time (for example, 2048 points). Then, a channel response is once estimated by setting, as the starting position of the FFT window, the preceding wave position P detected by the preceding wave position detection section 207. The circuit for obtaining the channel response is configured by the FFT sections 201 and 202, the channel response calculation section 203, and the IFFT section 204. The operation of each of the circuits is the same as the operation of each of the FFT sections 101 and 102, the channel response calculation section 103, and the IFFT section 104 in the first embodiment. Then, the maximum delay time τ is obtained by the delay time estimation section 205 by using the obtained channel response. In the second step, an accurate channel response is estimated in such a manner that on the basis of the relationship between the maximum delay time τ, the PN sequence length N, and the unique word length M, the size of FFT and IFFT is made variable according to the maximum delay time τ. When the estimation processing is switched from the first step to the second step, the switching section 208 switches from the output of the preceding wave position detection section 207 to the output of the delay time estimation section 205, and supplies the switched output to the FFT parameter determination section 206.

Note that the switching section 208 includes: for example, a switch configured to switch between the output of the preceding wave position detection section 207 and the output of the delay time estimation section 205; and a control section configured to perform control to switch the switch at the time of the shift from the first step to the second step, and switches from the output of the preceding wave position detection section 207 to the output of the delay time estimation section 205 at the time of the shift from the first step to the second step. Alternatively, it may also be configured such that the switching section 208 is configured only by a selector switch, such that the output of the preceding wave position detection section 207, and the output of the delay time estimation section 205 are monitored by the other control section (not shown), and such that the selector switch is switched at the time when the control section detects the shift from the first step to the second step. The other control section may be realized by a controller such as a CPU or an MPU in the receiver provided with the channel estimator.

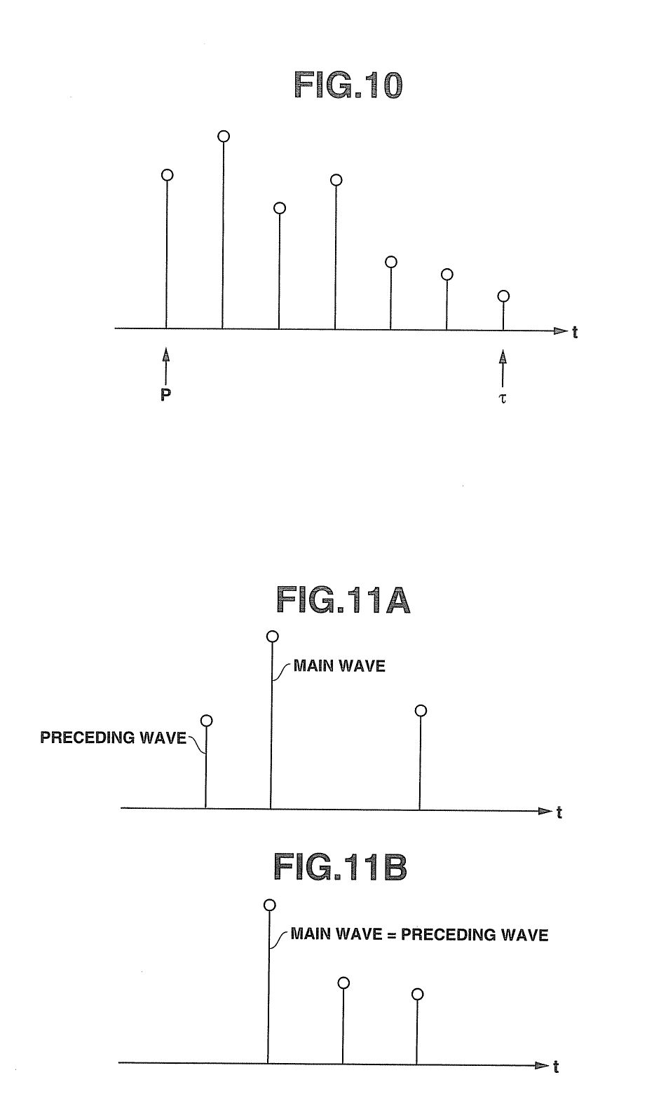

Here, FIG. 10 is a diagram in which a maximum delay time τ obtained by the delay time estimation section 205, and a preceding wave position P obtained by the preceding wave position detection section 207 are shown in correspondence with a plurality of peaks of a delay profile.

FIG. 11A and FIG. 11B are diagrams each of which shows a relationship between a preceding wave and a main wave on a delay profile. FIG. 11A is a diagram showing the case where the preceding wave is different from the main wave, while FIG. 11B is a diagram showing the case where the main wave is the preceding wave. The diagrams indicate that when the channel is line of sight (LOS) from the broadcasting station antenna to the receiver, the delay profile shown in FIG. 11B is obtained because the preceding wave having the highest peak level becomes the main wave, and that when the channel is NLOS from the broadcasting station antenna to the receiver, the delay profile shown in FIG. 11A is obtained because a reflection wave (delayed wave), which is delayed in time and which has the maximum level, becomes the main wave.

According to second embodiment, even in the case where a frame synchronization detection circuit, and the like, is not separately prepared, the preceding wave position detection processing is performed and a channel response is temporarily estimated in the state where the detected preceding wave position is set as the FFT window position and where the FFT size is maximized. Then, the FFT parameters (window position and size) are again determined on the basis of the maximum delay time obtained from the estimation result, so as to estimate the channel response by using the FFT with the minimum FFT size that can be set according to the obtained maximum delay time. Thereby, the channel estimation can be accurately performed with low power consumption without relying on the frame synchronization.

Note that in the channel estimator according to all the embodiments of the present invention, in the environment in which the channel delay spread is large, the peak accuracy of the output of the correlator, which performs correlation detection, may be slightly lowered because the amount of a preceding frame signal, which is delayed to enter the unique word portion of a subsequent frame, is large. In this case, the deterioration of channel estimation accuracy can be prevented in such a manner that the result obtained by estimating the delay profile of the preceding frame by using the channel estimator according to the present invention, and a signal obtained by re-modulating the demodulation result of the frame body (data section) of the preceding frame are used to generate replicas of the delayed signals which enter the next frame, and that the replicas of the delayed signals are subtracted from the next frame before the delay profile of the next frame is estimated.

In the above described embodiments, the case where a cyclic prefix and a cyclic postfix, each of which is formed by cyclically extending a specific code sequence (for example, PN sequence), are respectively included before and after the specific code sequence is explained as the frame configuration of the unique word. However, the channel estimator according to the present invention can also be similarly applied to the case of the unique word which includes only the specific code sequence and the cyclic prefix that is formed by cyclically extending the specific code sequence and that is arranged before the specific code sequence. Further, the channel estimator according to the present invention can also be similarly applied to the case of the unique word which includes only the specific code sequence and the cyclic postfix that is formed by cyclically extending the specific code sequence and that is arranged after the specific code sequence.

Further, the above described embodiments are described by using the PN sequence as the specific code sequence, but an arbitrary code sequence having high autocorrelation characteristics as code characteristics may also be used as the specific code sequence.

Note that the present invention is not limited to the above described embodiments, and various modification, changes or the like, are possible within the scope and spirit of the invention. Further, various configuration can be formed by adaptively combining a plurality of components disclosed in the above described embodiments. For example, some components may be eliminated from all the components shown in the above described embodiments. Further, components of different embodiments may also be adaptively combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A channel estimator used in a receiver in a radio system where the transmitted signal consists of continuous frames having a configuration in which a known pattern signal formed by cyclically extending a specific code sequence is periodically inserted, the channel estimator comprising:
a delay time estimation section configured to estimate a delay time of a received signal;
an FFT parameter determination section configured to determine an FFT window position and an FFT size according to the delay time estimated by the delay time estimation section;
a first FFT section configured to transform the received signal to the frequency domain on the basis of the FFT window position and the FFT size that are determined by the FFT parameter determination section;
a second FFT section configured to transform the known pattern signal to the frequency domain on the basis of the FFT size determined by the FFT parameter determination section;
a channel response calculation section configured to perform division processing to divide the FFT output of the first FFT section by the FFT output of the second FFT section; and
an IFFT section configured to apply IFFT to the output of the channel response calculation section on the basis of the FFT size determined by the FFT parameter determination section,
wherein the delay time estimation section estimates a delay time on the basis of the output of the IFFT section.

2. A channel estimator used in a receiver in a radio system where the transmitted signal consists of continuous frames having a configuration in which a known pattern signal formed by cyclically extending a specific code sequence is periodically inserted, the channel estimator comprising:
a preceding wave position detection section configured to detect the position of a preceding wave of a received signal;
a delay time estimation section configured to estimate a delay time of the received signal;
a switching section configured to select any one of the preceding wave position detected by the preceding wave position detection section and the delay time estimated by the delay time estimation section;
an FFT parameter determination section configured to determine an FFT window position and an FFT size on the basis of the output of the switching section;
a first FFT section configured to transform the received signal to the frequency domain on the basis of the FFT window position and the FFT size that are determined by the FFT parameter determination section;
a second FFT section configured to transform the known pattern signal to the frequency domain on the basis of the FFT size determined by the FFT parameter determination section;
a channel response calculation section configured to perform division processing to divide the FFT output of the first FFT section by the FFT output of the second FFT section; and
an IFFT section configured to apply IFFT to the output of the channel response calculation section on the basis of the FFT size determined by the FFT parameter determination section,
wherein the delay time estimation section estimates a delay time on the basis of the output of the IFFT section.

3. The channel estimator according to claim 1,
wherein the channel response calculation section calculates a channel response by a minimum mean square error algorithm.

4. The channel estimator according to claim 1,
wherein the FFT parameter determination section switches between a predetermined FFT size and an FFT size smaller than the predetermined FFT size according to the delay time estimated by the delay time estimation section.

5. The channel estimator according to claim 1,
wherein the respective FFT size of the first and second FFT sections and of the IFFT section is made variable according to the FFT size determined by the FFT parameter determination section.

6. The channel estimator according to claim 1,
wherein the delay time estimation section searches a path having maximum power in a delay profile obtained as the output of the IFFT section, recognizes, as delayed waves, paths each having a power level that is not smaller than the level attenuated by a predetermined level relative to the maximum power level of the searched path, and measures a delay time of each of the recognized delayed waves.

7. The channel estimator according to claim 1,
wherein the delay time is a maximum delay time of the latest delayed wave among a plurality of delayed waves recognized as delayed waves.

8. The channel estimator according to claim 1, wherein the FFT parameter determination section fixes, in a first step, the respective FFT and IFFT size of the first and second FFT sections and of the IFFT section to a maximum size that can be assumed as a multipath delay time, wherein on the basis of the fixed FFT size, the first and second FFT sections perform FFT and the IFFT section performs IFFT, wherein the delay time estimation section obtains a maximum delay time τ from the channel response obtained by the IFFT section, and wherein, in a next step, on the basis of a predetermined Equation expressing a relationship between the maximum delay time τ, a PN sequence length N, and the known pattern signal length M, the FFT parameter determination section makes the respective FFT size of the first and second FFT sections and of the IFFT section variable according to the maximum delay time ti so that an accurate channel response can be estimated.

9. The channel estimator according to claim 1, wherein the FFT window position is set as a time position expressed by Equation P+M−K, in the case where a preceding wave position is set as P, where the known pattern signal length is set as M, and where the FFT size is set as K.

10. The channel estimator according to claim 1, wherein the FFT window position is set to a delayed time of a latest delayed wave having power not less than a predetermined threshold value.

11. The channel estimator according to claim 1, wherein when it is assumed that the length of the known pattern signal is M; the length of a PN sequence, which is the specific code sequence in the known pattern signal, is N; a maximum delay time among multipath delayed waves is τ; one symbol time is T; and the FFT size is K, and when the maximum delay time τ is not more than the time ((M−N)T) corresponding to the cyclically extended portion of the PN sequence, the FFT size K is set to be not less than N points as the length of the PN sequence and not more than M points as the length of the known pattern signal so as to include the PN sequence of a preceding wave and all delayed waves or a signal sequence which is formed by cyclically extending the PN sequence.

12. The channel estimator according to claim 1, wherein when it is assumed that the length of the known pattern signal is M; the length of a PN sequence, which is the specific code sequence in the known pattern signal, is N; a maximum delay time among multipath delayed waves is τ; one symbol time is T; and the FFT size is K, and when the maximum delay time τ is larger than the time ((M−N)T) corresponding to the cyclically extended portion of the PN sequence, the FFT size K is set to a size larger than the number of points (M−N) corresponding to the cyclically extended portion.

13. The channel estimator according to claim 2, wherein the preceding wave position detection section continues to perform complex correlation processing between the known pattern signal and the received signal in the time domain, and determines, as the position of the preceding wave, a position at which a peak of the correlation value representing the correlation result is detected.

14. The channel estimator according to claim 13, wherein when the position of the preceding wave is varied for each frame, the preceding wave position detection section averages the correlation results between the known pattern signal and the plurality of frames.

15. The channel estimator according to claim 13, wherein when the position of the preceding wave is varied for each frame, the preceding wave position detection section sets a predetermined condition and performs synchronization protection to effect synchronization of the detected peak position between the frames.

16. The channel estimator according to claim 2, wherein the preceding wave position detection section continues to obtain correlation of a pair of a cyclic prefix and the end region of a PN sequence, or correlation of a pair of a cyclic postfix and the starting region of the PN sequence, the pair being a pair of cyclically extended portions between the known pattern signal and the received signal, and sets, as the preceding wave position, a position at which the correlation value becomes maximum.

17. The channel estimator according to claim 2, wherein the preceding wave position detection section obtains correlation between the known pattern signal including at least a PN sequence of a sequence length N and the received signal, and performs threshold determination in which when the power value of the correlation value representing the obtained correlation result is less than a threshold value, the correlation value is not regarded as corresponding to the preceding wave.

18. The channel estimator according to claim 2, wherein in a first step, the respective FFT and IFFT size of the first and second FFT sections, and of the IFFT section are fixed, by the preceding wave position detection section, to a maximum size which can be assumed as the multipath delay time, wherein a channel response is once estimated in the state where the preceding wave position detected by the preceding wave position detection section is set as the starting position of the FFT window, wherein a maximum delay time τ is obtained by the delay time estimation section by using the obtained channel response, wherein at the time of the shift from the first step to the next step, the circuit output of the switching section is switched by the switching section from the output of the preceding wave position detection section to the output of the delay time estimation section, and is supplied to the FFT parameter determination section, and wherein in the next step, an accurate channel response is estimated in such a manner that the respective FFT and IFFT size of the first and second FFT sections, and of the IFFT section are made variable by the FFT parameter determination section according to the maximum delay time τ and on the basis of a relationship between the maximum delay time τ, a PN sequence length N, and the known pattern signal length M.

19. The channel estimator according to claim 2, wherein the switching section is configured by including: a switch configured to switch between the output of the preceding wave position detection section and the output of the delay time estimation section; and a control section configured to perform control for switching the switch at the time when a first step is shifted to a next step, and is configured to switch the circuit output thereof from the output of the preceding wave position detection section to the output of the delay time estimation section at the time of the shift from the first step to the next step.

20. The channel estimator according to claim 2, wherein in the case where, in an environment of a large channel delay spread, because of a large amount of a preceding frame signal which is delayed in entering the known pattern signal portion of a subsequent frame, the peak accuracy of the output of the correlator configured to perform correlation detection is lowered, the deterioration of channel estimation accuracy is prevented in such a manner that the result obtained by estimating the delay profile of the preceding frame, and a signal obtained by re-modulating the demodulated result of the frame body as the data section of the preceding frame are used to generate a replica of the delayed signal which enters the subsequent frame, and that the replica of the delayed signal is subtracted from the subsequent frame before the delay profile of the subsequent frame is estimated.
